(19) United States
(12) Patent Application Publication
(10) Pub. No.: US 2024/0419296 A1
(43) Pub. Date: Dec. 19, 2024

(54) METHOD AND APPARATUS FOR CONTROLLING INTERFACE THEME OF VEHICLE DISPLAY TERMINAL

(71) Applicants: HYUNDAI MOTOR COMPANY, Seoul (KR); Kia Corporation, Seoul (KR)

(72) Inventor: Xiu Lei XIE, Shandong (CN)

(73) Assignees: HYUNDAI MOTOR COMPANY, Seoul (KR); Kia Corporation, Seoul (KR)

(21) Appl. No.: 18/620,172

(22) Filed: Mar. 28, 2024

(30) Foreign Application Priority Data
Jun. 16, 2023 (CN) 202310720804.8

(51) Int. Cl. G06F 3/0482; B60Q 9/00; G06Q 50/26; G07C 5/08

(52) U.S. Cl. CPC G06F 3/0482; B60Q 9/00; G06Q 50/26; G07C 5/0816

(57) ABSTRACT

In a method and an apparatus for controlling an interface theme of a vehicle display terminal, the vehicle display terminal is configured to provide a theme setting interface, and store a plurality of theme interface images. The method may include: obtaining driving data in a driving process of a vehicle user; determining a driving behavior score of the vehicle user based on the obtained driving data and a preset scoring mechanism; determining whether the determined driving behavior score reaches a predetermined value; and when it is determined that the driving behavior score reaches the predetermined value, allowing the vehicle user to select any one of a plurality of theme interface images through the theme setting interface.

### CROSS-REFERENCE TO RELATED APPLICATION

The present application claims priority to Chinese Patent Application No. 202310720804.8 filed in the Chinese National Intellectual Property Administration on Jun. 16, 2023, the entire contents of which is incorporated herein for all purposes by this reference.

### BACKGROUND OF THE PRESENT DISCLOSURE

### Field of the Present Disclosure

The present disclosure relates to a display theme technology for a vehicle, and particularly, to a method and an apparatus for controlling an interface theme of a vehicle display terminal.

### Description of Related art

A vehicle is typically equipped with multiple vehicle display terminals to display different information. For example, a cluster of the vehicle may display real-time vehicle information, such as vehicle speed, engine speed, cabin temperature, fuel consumption amount, and travel distance, to enable drivers to recognize a real-time state of the vehicle. In preparation of the fierce competition of the vehicle market, many vehicle manufacturers have improved interiors of the vehicles. More and more clusters use thin film transistor liquid crystal displays (TFT LCDs), such as 10.25-inch LCDs or 12.3-inch LCDs. As a result, vehicle manufacturers have designed various interface themes (or skins) for the clusters to make the cluster be more colorful and customized. However, the interface themes developed by the vehicle manufacturers usually have to be paid for. Because most vehicle users do not prefer to pay, the theme setting interface displayed in the cluster may be bland, and the functions that the vehicle manufacturers have worked hard to develop may sometimes be difficult to be displayed on a vehicle display terminal. Therefore, there is an urgent need for a method and an apparatus for controlling an interface theme of a vehicle display terminal that can provide a vehicle user with the interface theme through specific measures without requiring the vehicle user to pay a fee.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and an apparatus for controlling an interface theme of a vehicle display terminal, which are configured for providing a vehicle user with the interface theme without requiring the vehicle user to pay a fee.

According to an exemplary embodiment of the present disclosure, a method for controlling an interface theme of a vehicle display terminal is provided. The vehicle display terminal is configured to provide a theme setting interface, and store a plurality of theme interface images. The method may include: obtaining driving data in a driving process of a vehicle user; determining a driving behavior score of the vehicle user based on the obtained driving data and a preset scoring mechanism; determining whether the determined driving behavior score reaches a predetermined value; and upon concluding that the driving behavior score reaches the predetermined value, allowing the vehicle user to select any one of a plurality of theme interface images through the theme setting interface.

The driving data may include an average fuel efficiency parameter value of the vehicle, the number of newly occurring traffic regulation violations committed by the vehicle, and information on whether the vehicle user is in a drowsy driving state.

Obtaining the average fuel efficiency parameter value in the driving process of the vehicle user may include: collecting an amount of fuel consumption and a travel distance for a single driving stroke of the vehicle; and determining the average fuel efficiency parameter value based on the amount of fuel consumption and the travel distance of the vehicle in one driving stroke.

Obtaining the number of newly occurring traffic regulation violations during the driving process of the vehicle may include: collecting the cumulative number of traffic regulation violations of the vehicle at a predetermined time interval; determining a difference value between the cumulative numbers of traffic regulation violations collected during two adjacent driving strokes; and taking the difference value as the number of newly occurring traffic regulation violations committed by the vehicle.

The determining a driving behavior score of the vehicle user during the driving stroke may include: when the determined average fuel efficiency parameter value of the vehicle is equal to or lower than a preset optimal vehicle fuel efficiency parameter value, increasing the driving behavior score; when the determined number of newly occurring traffic regulation violations committed by the vehicle is not zero, decreasing the driving behavior score by a value related to the number of newly occurring traffic regulation violations committed by the vehicle; and upon concluding that the vehicle user is in the drowsy driving state, decreasing the driving behavior score.

The method may include, upon concluding that the driving behavior score reaches the predetermined value, resetting the driving behavior score to zero, and re-obtaining the driving data in the driving process of the vehicle user to redetermine the driving behavior score of the vehicle user.

The method may further include upon concluding that the vehicle user is in the drowsy driving state, displaying a warning message on the theme setting interface of the vehicle display terminal.

The theme setting interface may be provided with selection buttons that correspond to the theme interface images. The method may further include, when any one of the plurality of theme interface images is selected, in response to the selection of the corresponding selection button, setting the interface theme of the vehicle display terminal with the corresponding theme interface image.

The method may further include, upon concluding that the driving behavior score reaches the predetermined value, displaying a notification message on the theme setting interface of the vehicle display terminal, and the notification message may indicate that any one of the theme interface images is selectable.

The method may further include displaying the driving behavior score on the theme setting interface of the vehicle display terminal in a form of a figure image.

According to another exemplary embodiment of the present disclosure, an apparatus for controlling an interface theme of a vehicle display terminal is provided. The vehicle display terminal is configured to provide a theme setting interface, and store a plurality of theme interface images. The apparatus may include: an obtaining unit configured to obtain driving data in a driving process of a vehicle user; an integral calculation unit configured to determine a driving behavior score of the vehicle user based on the obtained driving data and a preset scoring mechanism; and a control unit configured to determine whether the determined driving behavior score reaches a predetermined value, upon concluding that the driving behavior score reaches the predetermined value, allow the vehicle user to select any one of a plurality of theme interface images through the theme setting interface.

The driving data may include an average fuel efficiency parameter value of the vehicle, the number of newly occurring traffic regulation violations committed by the vehicle, and information on whether the vehicle user is in a drowsy driving state.

The obtaining unit may be configured to, when the average fuel efficiency parameter value in the driving process of the vehicle is obtained, collect an amount of fuel consumption and a travel distance for a single driving stroke of the vehicle, and determine the average fuel efficiency parameter value based on the amount of fuel consumption and the travel distance of the vehicle in one driving stroke.

The obtaining unit may be configured to, when the number of newly occurring traffic regulation violations during the driving process of the vehicle is obtained, collect the cumulative number of traffic regulation violations of the vehicle at a predetermined time interval, determine a difference value between the cumulative numbers of traffic regulation violations collected during two adjacent driving strokes, and take the difference value as the number of newly occurring traffic regulation violations committed by the vehicle.

The integral calculation unit may be configured to, when the driving behavior score of the vehicle user during the driving stroke is determined, and when the determined average fuel efficiency parameter value of the vehicle is equal to or lower than a preset optimal vehicle fuel efficiency parameter value, increase the driving behavior score, when the determined number of newly occurring traffic regulation violations committed by the vehicle is not zero, decrease the driving behavior score by a value related to the number of newly occurring traffic regulation violations committed by the vehicle; and upon concluding that the vehicle user is in the drowsy driving state, decrease the driving behavior score.

The integral calculation unit may be further configured to, upon concluding that the driving behavior score reaches the predetermined value, reset the driving behavior score to zero and re-obtain driving data in the driving process of the vehicle user to redetermine the driving behavior score of the vehicle user.

The apparatus may further include a display unit configured to, upon concluding that the vehicle user is in the drowsy driving state, display a warning message on the theme setting interface of the vehicle display terminal.

The theme setting interface may be provided with selection buttons that correspond to the theme interface images, and the apparatus may further include a display unit configured to, when any one of the plurality of theme interface images is selected, in response to the selection of the corresponding selection button, set the interface theme of the vehicle display terminal with the corresponding theme interface image.

The apparatus may further include a display unit configured to, upon concluding that the driving behavior score reaches the predetermined value, display a notification message on the theme setting interface of the vehicle display terminal, and the notification message may indicate that any one of the theme interface images is selectable.

The apparatus may further include a display unit configured to display the driving behavior score on the theme setting interface of the vehicle display terminal in a form of a figure image.

The present disclosure adopts the above technical measures and has the following beneficial effects.

The present disclosure may provide the interface theme to the vehicle user through specific measures without requiring the vehicle user to pay for the interface theme. The vehicle users may obtain new display themes (for example, cluster skins) through these measures. The vehicle user may select a new cluster skin or maintain a default skin. Through the method, the cluster interface may be more colorful and customized. Furthermore, to get a desired cluster skin, the vehicle user should pay more attention to driving and obey traffic rules, which may help the vehicle user cultivate safe and civilized safety driving habits and improve traffic safety on the road.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram schematically illustrating a theme setting interface.

FIG. 2 is a diagram schematically illustrating a theme interface image corresponding to a selection button “DEFAULT”.

FIG. 3 is an overall flow chart of a method for controlling an interface theme of a vehicle display terminal according to an exemplary embodiment of the present disclosure.

FIG. 4 is a detailed flow chart of a method for controlling an interface theme of a vehicle display terminal according to an exemplary embodiment of the present disclosure.

FIG. 5 is a diagram schematically illustrating an interface of a vehicle display terminal when a vehicle user is determined to be in a drowsy driving state.

FIG. 6 is a schematic diagram of the theme setting interface of FIG. 1, and is a schematic diagram of the theme setting interface when a driving behavior score of a vehicle user reaches a predetermined value.

FIG. 7 is a diagram schematically illustrating a theme interface image corresponding to a selection button “SKIN A”.

FIG. 8A, FIG. 8B, FIG. 8C, and FIG. 8D illustrate interface images displaying a driving behavior score in a form of a star.

FIG. 9 is a block diagram of a system to which an apparatus for controlling an interface theme of a vehicle display terminal according to an exemplary embodiment of the present disclosure is applied.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, an exemplary embodiment of the present disclosure is described in detail, and the exemplary embodiment of the present disclosure is conducted on the premise of the technical scheme of the present disclosure, and the detailed exemplary embodiment and specific operation process are disclosed, but the scope of the present disclosure is not limited to the following exemplary embodiment of the present disclosure.

According to an exemplary embodiment of the present disclosure, a vehicle display terminal is configured to provide a theme setting interface, and store a plurality of theme interface images. The theme setting interface is provided with a selection button for each theme interface image that includes a one-to-one correspondence relationship with the theme interface image, and to display the selection buttons for all theme interface images. The theme setting interface may be implemented through a user settings menu (USM) of an audio video navigation telematics (AVNT) system.

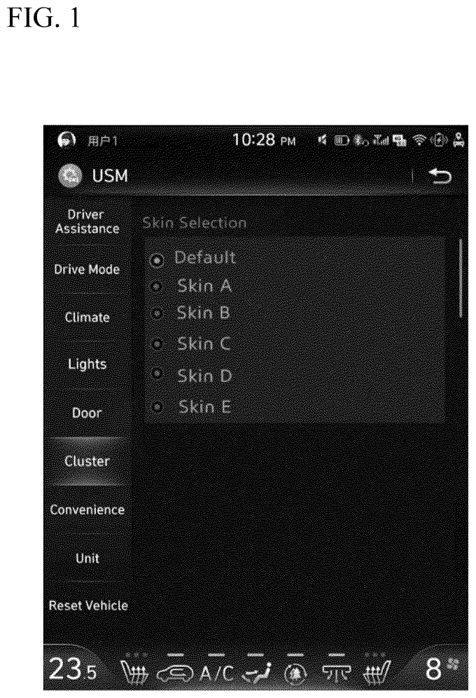

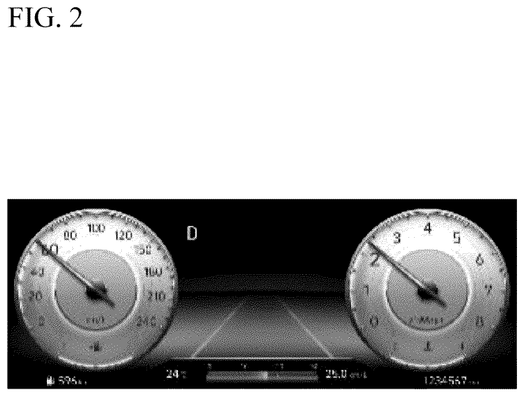

FIG. 1 is a diagram schematically illustrating a theme setting interface. As illustrated in FIG. 1, a theme setting interface displays “DEFAULT”, “SKIN A”, “SKIN B”, “SKIN C”, “SKIN D”, and “SKIN E”, which are the selection buttons for selecting the theme interface images. Herein, A, B, C, D, and E represent different interface themes (or skins). In the theme setting interface illustrated in FIG. 1, the selection button “DEFAULT” is selected by default, and each selection button corresponds to a set of theme interface images. FIG. 2 is a diagram schematically illustrating the theme interface image corresponding to the selection button “DEFAULT”. As illustrated in FIG. 2, a default theme interface image only shows a road, which makes an interface of the vehicle display terminal very monotonous.

In the instant case, the vehicle display terminal may only use the default theme interface image, and a vehicle user cannot select the selection button “SKIN A”, the selection button “SKIN B”, the selection button “SKIN C”, the selection button “SKIN D”, or the selection button “SKIN E” to use other colorful interface themes (or skins). A method for controlling the interface theme of the vehicle display terminal according to an exemplary embodiment of the present disclosure enables “SKIN A,” “SKIN B,” “SKIN C,” “SKIN D,” and “SKIN E” other than “DEFAULT” among the selection buttons to be activated and selected in the theme setting interface.

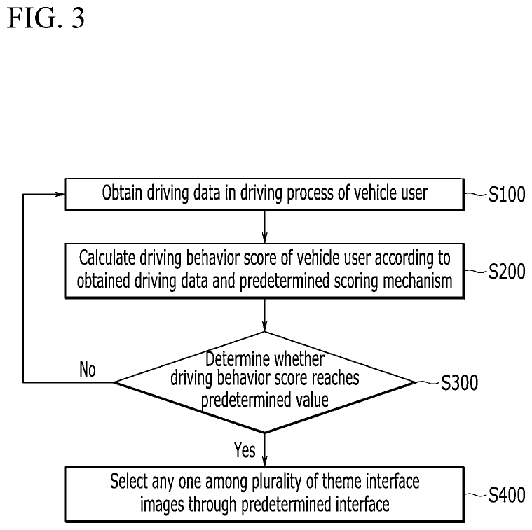

FIG. 3 is an overall flow chart of a method for controlling the interface theme of the vehicle display terminal according to an exemplary embodiment of the present disclosure. As illustrated in FIG. 3, the method for controlling the interface theme of the vehicle display terminal according to the exemplary embodiment of the present disclosure includes: obtaining driving data in a driving process of the vehicle user at step S100; determining a driving behavior score of the vehicle user according to the obtained driving data and a preset scoring mechanism at step S200; determining whether the determined driving behavior score reaches a predetermined value at step S300; and when it is determined that the driving behavior score reaches the predetermined value (“YES” at the step S300), causing the vehicle user to select any one of a plurality of theme interface images through the theme setting interface at step S400. That is, the method enables the vehicle user to select any one of the selection buttons in the theme interface image, other than the default button, in the theme setting interface.

Thus, according to the exemplary embodiment of the present disclosure, the interface theme (or skin) may be provided to the vehicle user through specific measures without the vehicle user having to pay for the interface theme. These measures need to evaluate the driving behavior of the user of the vehicle. Only when the driving behavior score of the vehicle user satisfies a condition (that is, reaches a predetermined value), the interface theme may be offered to the user as a reward.

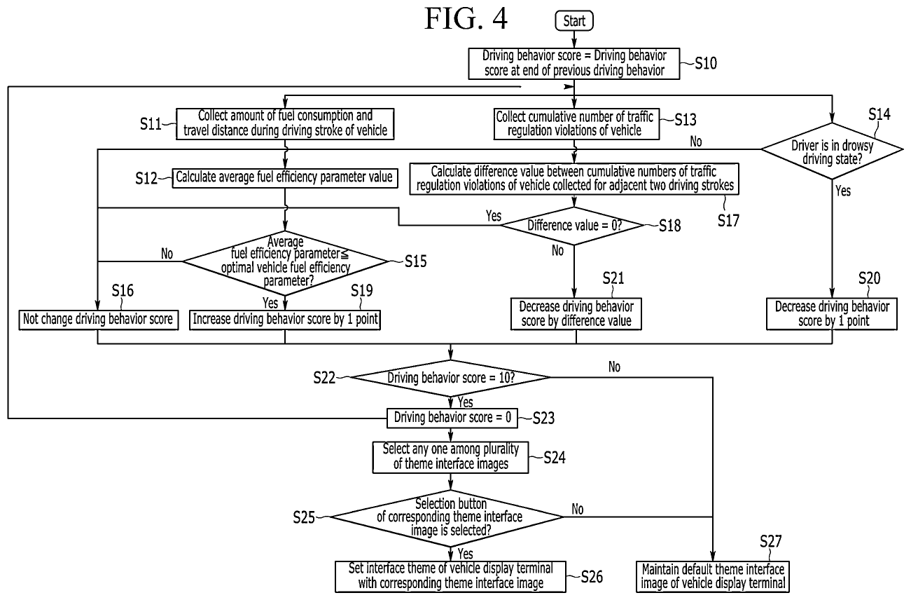

FIG. 4 is a detailed flow chart of the method for controlling the interface theme of the vehicle display terminal according to an exemplary embodiment of the present disclosure. As illustrated in FIG. 4, in one exemplary embodiment of the present disclosure, when the vehicle user starts the vehicle to initiate a single driving stroke, a current driving behavior score is equal to a driving behavior score at an end of a previous driving stroke at step S10. Then, the driving data of the driving process of the vehicle user is obtained. The driving data may include an average fuel efficiency parameter value of the vehicle, the number of newly occurring traffic regulation violations committed by the vehicle, and information on whether the vehicle user is in a drowsy driving state. The driving data reflects each of fuel efficiency, road civilization, and driving safety.

The obtaining the average fuel efficiency parameter value in the driving process of the vehicle may include: collecting an amount of fuel consumption and a travel distance during one driving stroke of the vehicle at step S11; and determining an average fuel efficiency parameter value based on the amount of fuel consumption and the travel distance during one driving stroke of the vehicle at step S12. In other words, the average fuel efficiency parameter value (L/100 km) may be determined by following formula.

Average fuel efficiency parameter value (L/100 km)=amount of fuel consumption (L)×100÷travel distance (km)

For example, when the travel distance of the vehicle is 50 km during the present driving stroke, and the amount of fuel consumption is 4 L, the average fuel efficiency parameter value of the vehicle is determined as 4 L×100÷50 km=8 L/100 km. The collection and determination steps may be implemented through a cluster.

The obtaining of the number of newly occurring traffic regulation violations committed by the driving process of the vehicle may include: collecting a cumulative number of traffic regulation violations of the vehicle at a predetermined time interval at step S13; determining a difference value between the cumulative numbers of traffic regulation violations collected during two adjacent driving strokes (that is, the difference value between the cumulative number of traffic regulation violations collected in the previous stroke and the cumulative number of traffic regulation violations collected in the current stroke) at step S17; and using the difference value as the number of newly occurring traffic regulation violations committed by the vehicle. The cumulative number of traffic regulation violations by the vehicle may be collected by application software used for transportation public services. The application software used for the transportation public services records the vehicle information, the cumulative number of traffic regulation violations of the vehicle, each traffic regulation violation behavior (for example, license plate violation, red light violation, seat belt violation, illegal parking violation, and lane reversal violation) and corresponding penalties. For example, the application software may be the “National Police Agency Internet Traffic Safety Comprehensive Service Management Platform” or other database in which the cumulative number of traffic regulation violations is stored. The application software may be provided on the AVNT system of the vehicle.

Furthermore, whether the vehicle user is in drowsy driving state may be determined through a driver attention warning (DAW) unit of an advanced driving assistance system (ADAS) at step S14. Specifiacally, the DAW unit may be configured to determine whether the vehicle user is in the drowsy driving state by determining whether the vehicle fails to keep a lane or is abnormally traveling through a front-facing camera or the like.

Then, based on the obtained driving data and the preset scoring mechanism, the driving behavior score of the vehicle user is determined at the S200. For example, the driving behavior score may be determined based on the average fuel efficiency parameter value of the vehicle, the number of traffic regulation violations that the vehicle has committed, and whether the vehicle user is in the drowsy driving state.

According to the exemplary embodiment of the present disclosure, the determined average fuel efficiency parameter value and a preset optimal vehicle fuel efficiency parameter value are compared at step S15, and when the average fuel efficiency parameter value of the vehicle is less than or equal to the preset optimal vehicle fuel efficiency parameter value (“YES” at the step S15), the driving behavior score is increased, for example, the driving behavior score is increased by one point at step S19. When the average fuel efficiency parameter value of the vehicle is greater than the preset optimal vehicle fuel efficiency parameter value (“NO” at the step S15), the current driving behavior score is not changed at step S16. Those skilled in the art may preset the optimal vehicle fuel efficiency parameter value based on a vehicle type. For example, the optimal vehicle fuel efficiency parameter value may be 4.7 L/100 km. If the average fuel efficiency parameter value during the present driving stroke of the vehicle is determined to be 8 L/100 km, 8 L/100 km is greater than 4.7 L/100 km, so that the vehicle user do not get any point for fuel savings during the present driving stroke.

According to the exemplary embodiment of the present disclosure, whether the number of newly occurring traffic regulation violations (that is, the difference value) committed by the vehicle is zero is determined at step S18, and when the difference value is zero (“YES” at the step S18), the current driving behavior score is not changed at the step S16. When the difference value is not zero (“NO” at the step S18), the driving behavior score is decreased by the value associated with the difference value, for example, the driving behavior score is decreased by the difference value at step S21.

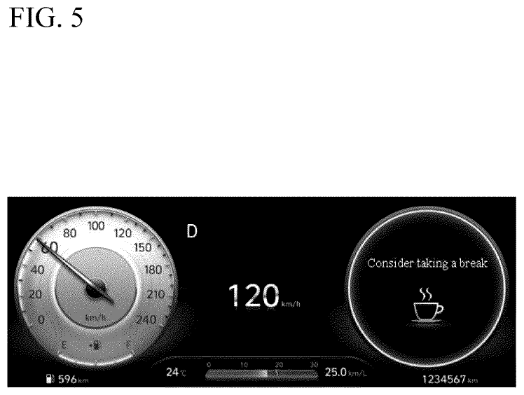

According to the exemplary embodiment of the present disclosure, when it is determined that the vehicle user is in the drowsy driving state (“YES” at the step S14), the driving behavior score is decreased, for example, the driving behavior score is decreased by one point at step S20. When it is not determined that the vehicle user is in the drowsy driving state (“NO” at the step S14), the current driving behavior score is not changed at the step S16. Furthermore, when it is determined that the vehicle user is in the drowsy driving state, the theme setting interface of the vehicle display terminal may cause a warning message to be displayed. FIG. 5 is a diagram schematically illustrating the theme setting interface of the vehicle display terminal when the vehicle user is determined to be in the drowsy driving state. As illustrated in FIG. 5, the warning message may be displayed on the theme setting interface of the vehicle display terminal to notify the vehicle user to take a break as soon as possible.

The scoring mechanism according to the exemplary embodiment of the present disclosure sets equal weights for the driving data reflecting the fuel efficiency, the road civilization, and the driving safety, but the present disclosure is not limited thereto, and different weights may be set for the driving data. For example, when the vehicle user achieves one fuel saving, one point may be added, while breaking the road rules and the drowsy driving may each be deducted two points.

During the determination step, it is determined whether the driving behavior score reaches a predetermined value (for example, the predetermined value may be 10) at step S22. The driving behavior score of 10 (“YES” at the step S22) means that the driving behavior of the vehicle user is good. Accordingly, the interface theme may be offered as the reward for the user to use the interface theme, that is, the vehicle user may select any one of a plurality of theme interface images at step S24. The theme interface image has a one-to-one correspondence relationship with the corresponding selection button, so that the selection button corresponding to a selectable theme interface image may be changed to a selectable selection button.

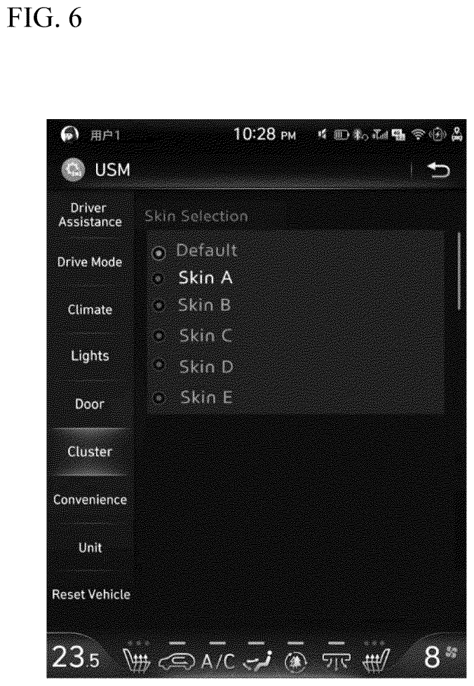

FIG. 6 is a schematic diagram of the theme setting interface of FIG. 1, and is a schematic diagram of the theme setting interface when the driving behavior score of the vehicle user reaches the predetermined value. In the theme setting interface illustrated in FIG. 1, the selection button “SKIN A” and the like cannot be selected. On the other hand, after the driving behavior score of the vehicle user reaches the predetermined value, the selection button “SKIN A” is selectable in the theme setting interface illustrated in FIG. 6.

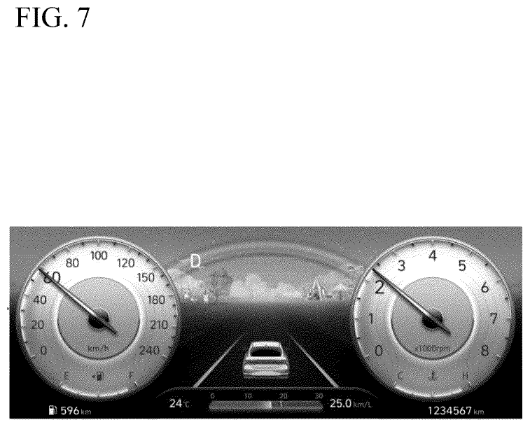

According to the exemplary embodiment of the present disclosure, when any one of the plurality of theme interface images is selectable at the step S24, it is determined whether the corresponding selection button is selected at step S25. In response to the selection of the corresponding selection button (“YES” at the step S25), the interface theme of the vehicle display terminal may be set with the corresponding theme interface image at step S26. Therefore, the vehicle user may set the interface theme of the vehicle display terminal by selecting the selection button “SKIN A” in the theme setting interface. FIG. 7 is a diagram schematically illustrating the theme interface image corresponding to the selection button “SKIN A”. Comparing FIG. 7 to FIG. 2, the theme setting interface of the vehicle display terminal is colorful and customized.

Correspondingly, when the corresponding selection button is not selected (“NO” at the step S25), that is, when the vehicle user does not select the selection button “SKIN A”, the theme interface of the vehicle display terminal still maintains the default theme interface image illustrated in FIG. 2 at step S27.

After the driving behavior score reaches the predetermined value (“YES” at the step S22), when any one of the plurality of theme interface images is selectable at the step S24, the method for controlling the interface theme of the vehicle display terminal according to the exemplary embodiment of the present disclosure resets the driving behavior score to zero at step S23. Accordingly, the driving data may be obtained again, and the driving behavior score of the vehicle may be determined according to the obtained driving data and the preset scoring mechanism at the step S11 to the step S22, so that another one of the theme interface images may be selected. The next selection button corresponding to the selectable theme interface image may be “Skin B”. In one example, according to the exemplary embodiment of the present disclosure, the selection button “SKIN A”, the selection button “SKIN B”, the selection button “SKIN C”, the selection button “SKIN D”, and the selection button “SKIN E” may be activated sequentially, and thus the selection button “SKIN A”, the selection button “SKIN B”, the selection button “SKIN C”, the selection button “SKIN D”, or the selection button “SKIN E” may be selected in the theme setting interface. Finally, due to the safe and civilized driving habits of the vehicle users, a full selection button may be selected in the theme setting interface.

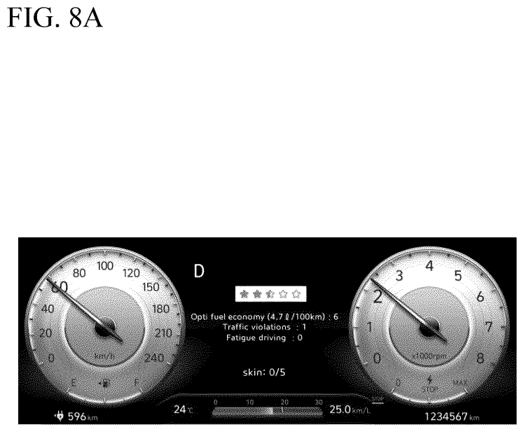

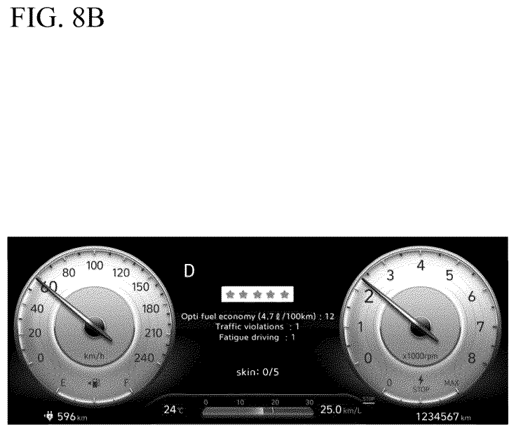

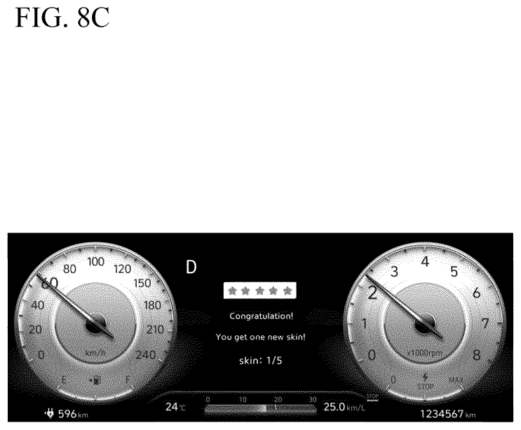

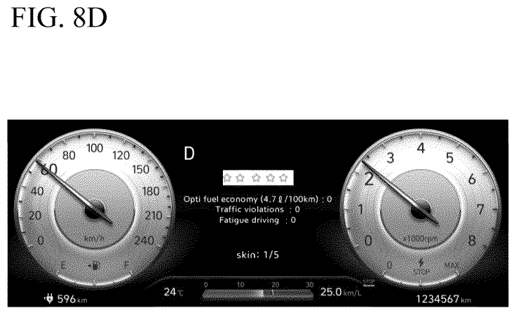

According to the exemplary embodiment of the present disclosure, the driving behavior score may be displayed on the theme setting interface of the vehicle display terminal in a form of a figure image. For example, the driving behavior score may be represented by a star. FIG. 8A, FIG. 8B, FIG. 8C, and FIG. 8D illustrate the theme setting interface images displaying the driving behavior score in a form of the star. The vehicle user may get one star for every two driving behavior points and get half a star for every one driving behavior point. As illustrated in FIG. 8A, when the vehicle user achieves six fuel savings, violates road rules one time, and is not in the drowsy driving state, the driving behavior score of the vehicle user is 5, and the vehicle user may get two and a half stars accordingly. As illustrated in FIG. 8B, when the vehicle user achieves 12 fuel savings, violates road rules one time, and has one drowsy driving incident, the driving behavior score of the vehicle user is 10, and the vehicle user may get five stars accordingly.

According to the exemplary embodiment of the present disclosure, when the driving behavior score is determined to reach the predetermined value, that is, five stars are obtained, the theme setting interface of the vehicle display terminal causes a notification message to be displayed. Here, the notification message indicates that the vehicle user is configured for selecting one of the selection buttons in the theme interface image. For example, FIG. 8C illustrates the notification message stating “Congratulations! You get one new skin!”. The notification message may remain for a time period (for example, may remain for 4S), or may appear continuously for multiple times (for example, appear continuously for a week). When there is no response to the notification message from the vehicle user within a reference time, the notification message is turned off

As illustrated in FIG. 8D, after the vehicle user gets 5 stars for the driving behavior score and the notification message is turned off, the driving behavior score resets back to 0 star.

According to another exemplary embodiment of the present disclosure, there is provided an apparatus for controlling an interface theme of a vehicle display terminal. The vehicle display terminal includes the theme setting interface. The apparatus for controlling the interface theme of the vehicle display terminal includes an obtaining unit, an integral calculation unit, and a control unit. The obtaining unit may be configured to obtain the driving data during the driving process of the vehicle user. The integral calculation unit is configured to determine the driving behavior score of the vehicle user according to the obtained driving data and the preset scoring mechanism. The control unit is configured to determine whether the determined driving behavior score reaches the predetermined value, and when it is determined that the driving behavior score reaches the predetermined value, to cause the vehicle user to select any one of the plurality of theme interface images through the theme setting interface.

In an exemplary embodiment of the present disclosure, the integral calculation unit and the control unit may be intergrated into the control unit.

In one exemplary embodiment of the present disclosure, the driving data includes the average fuel efficiency parameter value of the vehicle, the number of newly occurring traffic regulation violations committed by the vehicle, and the information on whether the vehicle user is in the drowsy driving state.

The obtaining unit may collect the amount of fuel consumption and the travel distance of one driving stroke of the vehicle, and determine the average fuel efficiency parameter value based on the amount of fuel consumption and the travel distance of one driving stroke of the vehicle.

The obtaining unit may collect the cumulative number of traffic regulation violations of the vehicle at the predetermined time interval, determine the difference value between the numbers of cumulative traffic regulation violations collected during two adjacent driving strokes, and take the difference value as the number of newly occurring traffic regulation violations committed by the vehicle.

The obtaining unit may collect the information from the DAW unit included in the ADAS about whether the vehicle user is in the drowsy driving state.

The integral calculation unit is configured to increase the driving behavior score when the determined average fuel efficiency parameter value of the vehicle is equal to or lower than the preset optimal vehicle fuel efficiency parameter value; decrease the driving behavior score by the value related to the number of newly occurring traffic regulation violations committed by the vehicle when the number of determined newly occurring traffic regulation violations committed by the vehicle is not zero; and decrease the driving behavior score when the vehicle user is determined to be in the drowsy driving state. The integral calculation unit is further configured to, when it is determined that the driving behavior score reaches the predetermined value, reset the driving behavior score to zero and redetermine the driving behavior score of the vehicle user by re-obtaining the driving data of the vehicle user in the driving process.

The theme setting interface is provided with the selection buttons that correspond to the theme interface images. The apparatus for controlling the interface theme of the vehicle display terminal may further include a display unit. The display unit may be configured to, when any one of the plurality of theme interface images is selected, set the interface theme of the vehicle display terminal with the corresponding theme interface image in response to the selection of the corresponding selection button. When it is determined that the vehicle user is in the drowsy driving state, the display unit may be further configured to display the warning message on the theme setting interface of the vehicle display terminal. When it is determined that the driving behavior score reaches the predetermined value, the display unit may be configured to display the notification message on the theme setting interface of the vehicle display terminal, and herein, the notification message indicates that any one of the theme interface images is selectable. Furthermore, the display unit may be configured to display the driving behavior score in a form of the figure image on the theme setting interface of the vehicle display terminal.

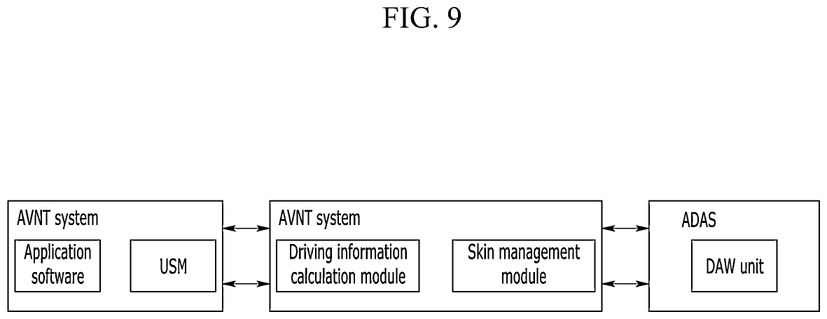

FIG. 9 is a block diagram of a system to which the apparatus for controlling the interface theme of the vehicle display terminal according to the exemplary embodiment of the present disclosure is applied. As illustrated in FIG. 9, the AVNT system includes the application software for transportation public services and the USM. The cluster includes a driving information determination module and a skin management module. The ADAS includes the DAW unit.

The theme setting interface of the vehicle display terminal may be implemented through the USM of the AVNT system. The theme setting interface of the vehicle display terminal may be the theme setting interface of the cluster.

The obtaining unit may be implemented via the cluster, the AVNT system, and the ADAS. Because a storage unit included in the cluster stores the amount of fuel consumption and the travel distance during the driving stroke of the vehicle, the collection, by the obtaining unit, the amount of fuel consumption and the travel distance during one driving stroke of the vehicle may be implemented through the storage unit of the cluster. Subsequently, by the driving information determination module included in the cluster, the obtaining unit may implement the determination of the average fuel efficiency parameter value. The application software used for the transportation public services may record the vehicle information, the cumulative number of traffic regulation violations of the vehicle, each traffic regulation violation behavior, and the corresponding penalty. The cluster may collect the cumulative number of traffic regulation violations of the vehicle from the application software used for the transportation public services, determine the difference value between the cumulative numbers of traffic regulation violations collected during two adjacent driving strokes, and take the difference value as the number of newly occurring traffic regulation violations committed by the vehicle. The DAW unit included in the ADAS may be configured to determine whether the vehicle user is in the drowsy driving state, and the cluster may collect information from the DAW unit on whether the vehicle user is in the drowsy driving state.

The integral calculation unit and the control unit may be implemented through the skin management module included in the cluster. The skin management module is configured to determine the driving behavior score of the vehicle user based on the obtained driving data and the preset scoring mechanism. The skin management module is configured to determine whether the determined driving behavior score reaches the predetermined value. When it is determined that the driving behavior score reaches the predetermined value, the skin management module allows the vehicle user to select any one of the plurality of theme interface images through the theme setting interface. In response to the selection of the corresponding selection button, the skin management module causes the interface theme of the vehicle display terminal to be set with the corresponding theme interface image. Finally, the vehicle user may obtain the desired cluster skin.

In an exemplary embodiment of the present disclosure, the cluster communicates with the AVNT system through the MINI-CAN bus, and the cluster communicates with the ADAS through the C-CAN bus.

The method and the apparatus for controlling the interface theme of the vehicle display terminal according to the exemplary embodiment of the present disclosure may provide the interface theme to the vehicle user through specific measures without requiring the vehicle user to pay a fee. The vehicle user may obtain a new display theme (for example, a cluster skin) through the measures, and select the new cluster skin or maintain the default skin. Through the method, the cluster interface may be looked more colorful and customized. Furthermore, to get the desired cluster skin, the vehicle user should pay more attention to driving and obey traffic rules, which may help the vehicle user cultivate safe and civilized safety habits and improve traffic safety on the road.

Various exemplary embodiments of the present disclosure do not list all possible combinations, but are intended to illustrate representative aspects of the present disclosure, and the contents described in various exemplary embodiments of the present disclosure may be applied independently or in combination of two or more.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for controlling an interface theme of a vehicle display terminal which includes a theme setting interface and stores a plurality of theme interface images, the method comprising:
obtaining driving data in a driving process of a vehicle user;
determining a driving behavior score of the vehicle user based on the obtained driving data and a preset scoring mechanism;
determining, by a control unit, whether the determined driving behavior score reaches a predetermined value; and
upon concluding that the driving behavior score reaches the predetermined value, allowing, by the control unit, the vehicle user to select any one of the plurality of theme interface images through the theme setting interface.

2. The method of claim 1, wherein the obtaining of the driving data includes obtaining an average fuel efficiency parameter value of a vehicle, a number of newly occurring traffic regulation violations committed by the vehicle, and information on whether the vehicle user is in a drowsy driving state.

3. The method of claim 2, wherein the obtaining of the average fuel efficiency parameter value in the driving process of the vehicle user includes:
collecting an amount of fuel consumption and a travel distance for a single driving stroke of the vehicle; and
determining the average fuel efficiency parameter value based on the amount of fuel consumption and the travel distance of the vehicle in one driving stroke.

4. The method of claim 2, wherein the obtaining of the number of newly occurring traffic regulation violations during the driving process of the vehicle includes:
collecting a cumulative number of traffic regulation violations of the vehicle at a predetermined time interval;
determining a difference value between cumulative numbers of traffic regulation violations collected during two adjacent driving strokes; and
taking the difference value as the number of newly occurring traffic regulation violations committed by the vehicle.

5. The method of claim 2, wherein the determining of the driving behavior score of the vehicle user during the driving stroke includes:
in response that the determined average fuel efficiency parameter value of the vehicle is equal to or lower than a preset optimal vehicle fuel efficiency parameter value, increasing the driving behavior score;
in response that the determined number of newly occurring traffic regulation violations committed by the vehicle is not zero, decreasing the driving behavior score by a value related to the number of newly occurring traffic regulation violations committed by the vehicle; and
upon concluding that the vehicle user is in the drowsy driving state, decreasing the driving behavior score.

6. The method of claim 5, wherein upon concluding that the driving behavior score reaches the predetermined value, the driving behavior score is reset to zero and the driving data in the driving process of the vehicle user is re-obtained to redetermine the driving behavior score of the vehicle user.

7. The method of claim 5, further including:
upon concluding that the vehicle user is in the drowsy driving state, displaying a warning message on the theme setting interface of the vehicle display terminal.

8. The method of claim 1,
wherein the theme setting interface is provided with selection buttons that correspond to the theme interface images, and
wherein the method further includes: in response that any one of the plurality of theme interface images is selected, in response to selection of a corresponding selection button among the selection buttons, setting the interface theme of the vehicle display terminal with a corresponding theme interface image.

9. The method of claim 1, further including:
upon concluding that the driving behavior score reaches the predetermined value, displaying a notification message on the theme setting interface of the vehicle display terminal,
wherein the notification message indicates that any one of the theme interface images is selectable.

10. The method of claim 1, further including:
displaying the driving behavior score on the theme setting interface of the vehicle display terminal in a form of a figure image.

11. An apparatus for controlling an interface theme of a vehicle display terminal which includes a theme setting interface and store a plurality of theme interface images, the apparatus comprising:
an obtaining unit configured to obtain driving data in a driving process of a vehicle user;
an integral calculation unit configured to determine a driving behavior score of the vehicle user based on the obtained driving data and a preset scoring mechanism; and
a control unit configured to determine whether the determined driving behavior score reaches a predetermined value, upon concluding that the behavior score reaches the predetermined value, allow the vehicle user to select any one of the plurality of theme interface images through the theme setting interface.

12. The apparatus of claim 11, wherein the driving data includes an average fuel efficiency parameter value of a vehicle, a number of newly occurring traffic regulation violations committed by the vehicle, and information on whether the vehicle user is in a drowsy driving state.

13. The apparatus of claim 12, wherein the obtaining unit is configured to, in response that the average fuel efficiency parameter value in the driving process of the vehicle is obtained, collect an amount of fuel consumption and a travel distance for a single driving stroke of the vehicle, and determine the average fuel efficiency parameter value based on the amount of fuel consumption and the travel distance of the vehicle in one driving stroke.

14. The apparatus of claim 12, wherein the obtaining unit is configured to, in response that the number of newly occurring traffic regulation violations during the driving process of the vehicle is obtained, collect a cumulative number of traffic regulation violations of the vehicle at a predetermined time interval, determine a difference value between cumulative numbers of traffic regulation violations collected during two adjacent driving strokes, and take the difference value as the number of newly occurring traffic regulation violations committed by the vehicle.

15. The apparatus of claim 12, wherein the integral calculation unit is configured to, in response that the driving behavior score of the vehicle user during the driving stroke is determined, and in response that the determined average fuel efficiency parameter value of the vehicle is equal to or lower than a preset optimal vehicle fuel efficiency parameter value, increase the driving behavior score, in response that the determined number of newly occurring traffic regulation violations committed by the vehicle is not zero, decrease the driving behavior score by a value related to the number of newly occurring traffic regulation violations committed by the vehicle; and upon concluding that the vehicle user is in the drowsy driving state, decrease the driving behavior score.

16. The apparatus of claim 15, wherein the integral calculation unit is further configured to, upon concluding that the driving behavior score reaches the predetermined value, reset the driving behavior score to zero and re-obtain driving data in the driving process of the vehicle user to redetermine the driving behavior score of the vehicle user.

17. The apparatus of claim 15, further including:
a display unit configured to, upon concluding that the vehicle user is in the drowsy driving state, display a warning message on the theme setting interface of the vehicle display terminal.

18. The apparatus of claim 11,
wherein the theme setting interface is provided with selection buttons that correspond to the theme interface images, and
wherein the apparatus further includes a display unit configured to, in response that any one of the plurality of theme interface images is selected, in response to selection of a selection button among the selection buttons, set the interface theme of the vehicle display terminal with a corresponding theme interface image.

19. The apparatus of claim 11, further including:
a display unit configured to, upon concluding that the driving behavior score reaches the predetermined value, display a notification message on the theme setting interface of the vehicle display terminal,
wherein the notification message indicates that any one of the theme interface images is selectable.

20. The apparatus of claim 11, further including: a display unit configured to display the driving behavior score on the theme setting interface of the vehicle display terminal in a form of a figure image.
